(19) United States
(12) Patent Application Publication
(10) Pub. No.: US 2016/0057816 A1
(43) Pub. Date: Feb. 25, 2016

(54) METHOD AND SYSTEM OF A SMART-MICROWAVE OVEN

(71) Applicants: NIBU ALIAS, ERNAKULAM (IN); ARJUN SARATH, ALAPPUZHA (IN); ANI ABRAHAM JOY, ERNAKULAM (IN)

(72) Inventors: NIBU ALIAS, ERNAKULAM (IN); ARJUN SARATH, ALAPPUZHA (IN); ANI ABRAHAM JOY, ERNAKULAM (IN)

(21) Appl. No.: 14/467,050

(22) Filed: Aug. 25, 2014

(51) Int. Cl. H05B 6/64; H05B 6/66

(52) U.S. Cl. CPC H05B 6/6435; H05B 6/6438; H05B 6/6441; H05B 6/668

(57) ABSTRACT

In one exemplary aspect, a smart-oven system includes a recipe module accessing a remote recipe database that comprises one or more recipe instructions, and downloading a downloaded recipe instruction to a local memory of the smart oven. A user-input module receives a user-specified cooking instruction. A cooking module manages one or more oven heating mechanisms in the smart oven according to the downloaded recipe instruction and the user-specified cooking instruction. A personalization module obtains a personalized recipe from a user of the smart oven and uploading the personalized recipe to a remote recipe database. A crowd sourcing module records user entered recipe instructions and automatically calculates cooking time and constitutes both into a complete recipe to be uploaded in the recipe store.

### BACKGROUND

1. Field

This application relates generally to ovens, and more specifically to a system, article of manufacture and method of a smart oven.

2. Related Art

A microwave oven can be a device that cooks food by using microwave energy generated from magnetron. Current microwave ovens have both manual cooking functions and automatic cooking functions. When the manual cooking function enables a user to adjust the output level and cooking time manually, the automatic cooking function cooks food automatically by selecting an item from menu without separately adjusting the cooking time. Automatic cooking functions in current microwave ovens are preset and static. In view of this, improvements may be made over conventional methods if, for example, a user were able to download recipes from a remote crowd-sourced database and/or modified said recipes. These recipes could then be automatically executed by the microwave oven.

### BRIEF SUMMARY OF THE INVENTION

In one aspect, a smart-oven system includes a recipe module accessing a remote recipe database that comprises one or more recipe instructions, and downloading a downloaded recipe instruction to a local memory of the smart oven. A user-input module receives a user-specified cooking instruction. A cooking module manages one or more oven heating mechanisms in the smart oven according to the downloaded recipe instruction and the user-specified cooking instruction. A personalization module obtains a personalized recipe from a user of the smart oven and uploading the personalized recipe to a remote recipe database. A crowd sourcing module records user entered recipe instructions and automatically calculates cooking time and constitutes both into a complete recipe to be uploaded in the recipe store.

Optionally, the user-specified cooking instructions can include a modification of the downloaded recipe. The modification of the downloaded recipe is uploaded by the personalization module to the remote recipe database. The modification of the downloaded recipe is stored in the remote recipe database if the modification of the downloaded recipe comprises a minimum of three steps, at least one oven trigger signal, a fixed temperature range, and a fixed cooking time range.

### BRIEF DESCRIPTION OF THE DRAWINGS

The present application can be best understood by reference to the following description taken in conjunction with the accompanying figures, in which like parts may be referred to by like numerals.

FIG. 1 depicts a system of smart-microwave oven, according to some embodiments.

FIG. 2 depicts, in block diagram format, various sub-systems of a smart-microwave oven, according to some embodiments.

FIG. 3 depicts an exemplary computing system that can be configured to perform any one of the processes provided herein.

FIG. 4 is a block diagram of a sample computing environment that can be utilized to implement some embodiments.

FIG. 5 illustrates an example set of processes performed by microprocessor of a smart-microwave oven, according to some embodiments.

FIG. 6 illustrates a process flow of control of personalization of a smart-microwave oven based on user preferences (e.g. recipes, region and/or country), according to some embodiments.

FIG. 7 illustrates a process flow of crowd-sourcing recipes, according to some embodiments.

FIG. 8 illustrates an example process for decoding a recipe for a smart-microwave oven, according to some embodiments.

The Figures described above are a representative set, and are not an exhaustive with respect to embodying the invention.

### DESCRIPTION

Disclosed are a system, method, and article of manufacture of a smart-microwave oven, according to some embodiments. The following description is presented to enable a person of ordinary skill in the art to make and use the various embodiments. Descriptions of specific devices, techniques, and applications are provided only as examples. Various modifications to the examples described herein may be readily apparent to those of ordinary skill in the art, and the general principles defined herein may be applied to other examples and applications without departing from the spirit and scope of the various embodiments.

Reference throughout this specification to “one embodiment,” “an embodiment,” “one example,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### DEFINITIONS

Cloud computing can include the delivery of computing as a service, whereby shared resources, software, and information are provided to computers over a network (e.g. the Internet).

Crowdsourcing can include the process of obtaining needed services, ideas, or content by soliciting contributions from a large group of people, and especially from an online community, rather than from traditional employees or suppliers.

Gesture recognition can include a topic in computer science and language technology with the goal of interpreting human gestures via mathematical algorithms. Gestures can originate from any bodily motion or state but commonly originate from the face or hand.

Oven trigger can be any action that affects the operation of the oven. It can include such actions as, inter alia: a start, stop, setting the time or setting the temperature of the oven.

Smart device, in one example, can include a securely managed electronic system that runs a high-level operating system and autonomously: connects to the Internet (and/or other computer networks), executes native and/or cloud-based applications, and/or analyzes data collected.

Switched-mode power supply (SMPS) can be an electronic power supply that incorporates a switching regulator to convert electrical power efficiently.

Exemplary Computing Systems, Environment and Architecture

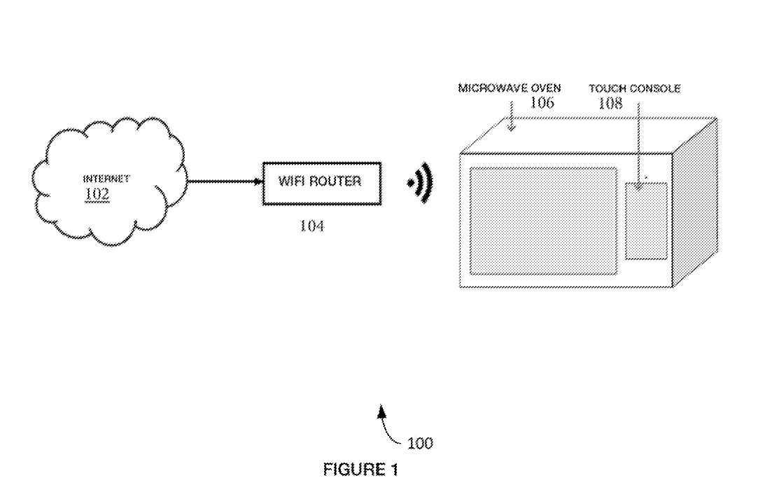

FIG. 1 depicts a system 100 of smart-microwave oven, according to some embodiments. System 100 can include a smart-microwave oven 106 communicatively coupled with other computing devices (e.g. mobile devices, personal computers, servers, etc.) via a computer network such as the Internet 102 and/or local networking devices (e.g. WiFi modem 104). Smart-microwave oven 106 can be operated by an operating system (e.g. operated by an Android® or Linux®Operating system). Smart-microwave oven 106 can communicate directly with internet through Wi-Fi modem 104 as it involves an operating system which controls the oven and no special section is needed for receiving data and perform cooking O0rations. Smart-microwave oven 106 has no need of external device as well as no voltage level converters is required. Smart-microwave oven 106 can operate a user input system (e.g. a touch screen LCD panel). Said touchscreen panel can include a single section, as well as, various operation specific input buttons (and/or virtual buttons displayed as software application icons) such as, inter alia, cooking, selecting recipe, etc. Various software application icons can appears on said touch screen LCD panel. A user touch can perform various manual input actions on its touch screen with his/her fingers. Smart-microwave oven 106 can automatically synchronize all recipes from a webserver (e.g. see infra) to its memory whenever it connects to Internet 102. Accordingly, many recipes can be stored in a local datastore of the smart-microwave oven 106. Smart-microwave oven 106 can include voice recognition functionalities for user input means to control its operations. Smart-microwave oven 106 can include a proximity sensor (and/or other gesture-recognition input device such as, inter alia: depth-aware cameras, stereo cameras, 2D camera, wearable motion sensors, etc. and/or any combination thereof) for controlling its operations. Smart-microwave oven 106 can understand and/or learn user preferences and display various personalized recipes and/or cooking tips. Smart-microwave oven 106 can provide access to a server in a cloud-computing functionality that can access a datastore of crowd-sourced recipes (e.g. see infra). Smart-microwave oven 106 can include heating managers that manages the operation of any food-item heating systems (e.g. heating elements, microwaves, convection heaters, etc.). Smart-microwave oven 106 can include timing managers that manages the time period of cooking food items.

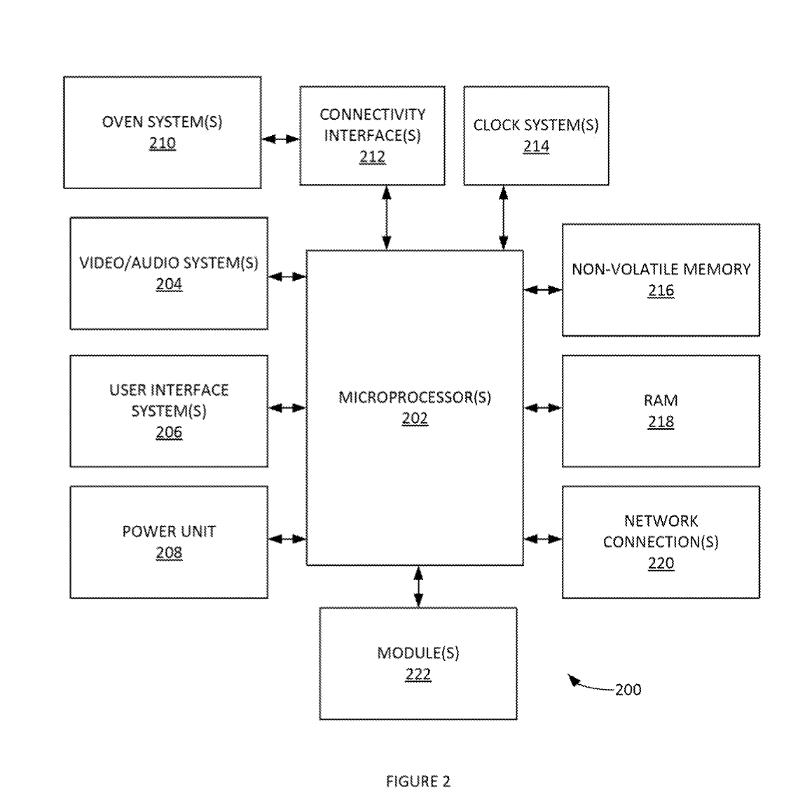

FIG. 2 depicts, in block diagram format, various sub-systems of a smart-microwave oven, according to some embodiments. For example, smart-microwave oven 106 can include various smart-oven systems 210 such as, inter alia: a convection relay, a microwave relay, a grill relay, microcontroller, a fan and/or a motor relay. Each subsystem can be individually connected to a microcontroller. The microcontroller can be connected to a microprocessor unit 202 (e.g. via connectivity interface(s) 212 utilizing USB, RS232, RS422, RS485, SPI or I2C protocol controls). System 200 can include clock system(s) 214 with real-time clock signals by a crystals means. A random access memory (RAM) 218 (e.g. Double Data Rate Synchronous Dynamic Random Access Memory) can be coupled with microprocessor 202 to facilitate dynamic data acquisition from the data storage. A non-volatile memory 216 (e.g. I2C Flash, SPI Flash, SD/MMC/MMC Plus, NAND Flash, etc.) can be coupled with microprocessor 202. A user interface system(s) can be coupled with microprocessor 202. Example user interfaces can include a touch screen along with LCD display with back light, proximity sensors, microphones, speakers, and the like. Local network connectivity can be provided with network connection(s) 220. For example, WIFI and Bluetooth connectivity can be provided to microprocessor 202 to connect with external devices and/or the Internet 102. Power supply unit 208 can provide microprocessor 202 with a battery backup. In one example, power supply unit 208 can include an SMPS unit which supplies a steady twelve volt (12v) supply regulated as five volts (5v) or three point three volts (3.3v) supply depends on type of microprocessor. Other subsystems can be included. For example, a door sensor can be used to monitor whether the door is closed or open to avoid any hazardous events due to microwave or heat. Smart-oven systems 210 can include modules 222 for controlling various functionalities. For example, a module can be included for optimizing cooking time (e.g. via crowd sourcing techniques combined with optimization and/or machine learning algorithms). For example, recipes in the recipe store can be continuously improved by gathering data from various users. The users can have the option to add or reduce cooking time by editing the downloaded the recipe. From these edits, over the time, the time and temperature for cooking a dish can be automatically optimized. An API module can be provided in some embodiments. Modules 222 can include an API module in the smart-oven system that enables the smart-oven system to connect to other computing devices. This is an implementation of internet of things concept and machine to machine communication. An application programming interface (API) can be provided for third-party developers to connect to smart-oven system and use information from it for various purposes. This API module can also be used to develop apps/devices to control the smart-oven system. The API module can also be used to send information about recipes over to other devices. The crowd sourcing module can also be available in the website of that provides information to various smart-oven systems 210 and/or supporting servers. The crowd sourcing can be done by the user entering the ingredients and steps in the text area provided in the website. The recipe can then be stored in a web server and made available to the users of smart-oven systems 210.

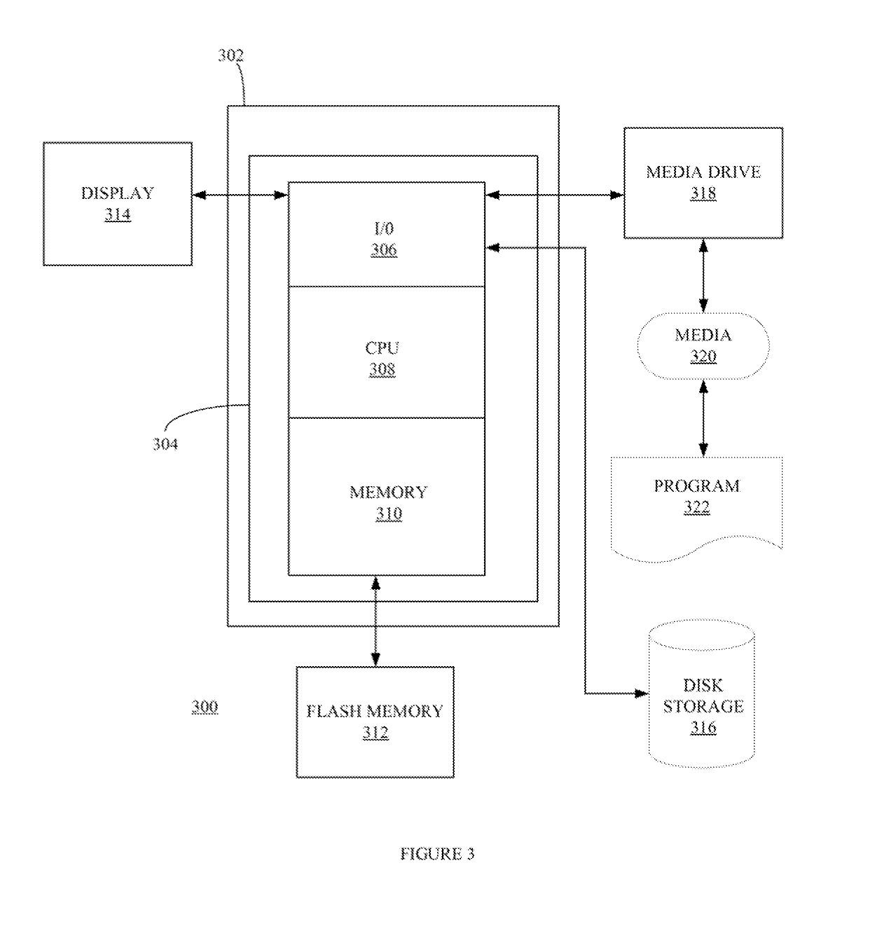

FIG. 3 depicts an exemplary computing system 300 that can be configured to perform any one of the processes provided herein. In this context, computing system 300 may include, for example, a processor, memory, storage, and I/O devices (e.g., monitor, keyboard, disk drive, Internet connection, etc.). However, computing system 300 may include circuitry or other specialized hardware for carrying out some or all aspects of the processes. In some operational settings, computing system 300 may be configured as a system that includes one or more units, each of which is configured to carry out some aspects of the processes either in software, hardware, or some combination thereof.

FIG. 3 depicts computing system 300 with a number of components that may be used to perform any of the processes described herein. The main system 302 includes a motherboard 304 having an I/O section 306, one or more central processing units (CPU) 308, and a memory section 310, which may have a flash memory card 312 related to it. The I/O section 306 can be connected to a display 314, a keyboard and/or other user input (not shown), a disk storage unit 316, and a media drive unit 318. The media drive unit 318 can read/write a computer-readable medium 320, which can contain programs 322 and/or data. Computing system 300 can include a web browser. Moreover, it is noted that computing system 300 can be configured to include additional systems in order to fulfill various functionalities. Computing system 300 can communicate with other computing devices based on various computer communication protocols such a Wi-Fi, Bluetooth® (and/or other standards for exchanging data over short distances includes those using short-wavelength radio transmissions), USB, Ethernet, cellular, etc.

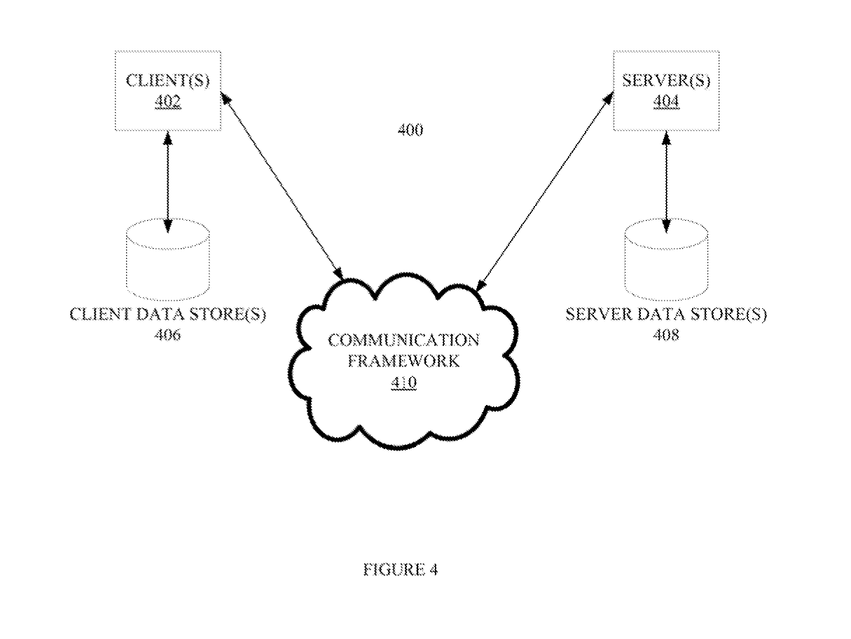

FIG. 4 is a block diagram of a sample computing environment 400 that can be utilized to implement some embodiments. The system 400 further illustrates a system that includes one or more client(s) 402. The client(s) 402 can be hardware and/or software (e.g., threads, processes, computing devices). The system 400 also includes one or more server(s) 404. The server(s) 404 can also be hardware and/or software (e.g., threads, processes, computing devices). One possible communication between a client 402 and a server 404 may be in the form of a data packet adapted to be transmitted between two or more computer processes. The system 400 includes a communication framework 410 that can be employed to facilitate communications between the client(s) 402 and the server(s) 404. The client(s) 402 are connected to one or more client data store(s) 406 that can be employed to store information local to the client(s) 402. Similarly, the server(s) 404 are connected to one or more server data store(s) 408 that can be employed to store information local to the server(s) 404.

FIG. 4 is provided by way of example, in other embodiments, the methods and systems provided herein can be implemented in cloud-computing environments such as the Amazon.com's® cloud-computing services For example, system 200 can be implemented as a virtual machine(s) in a cloud-computing environment.

Exemplary Processes and Use Cases

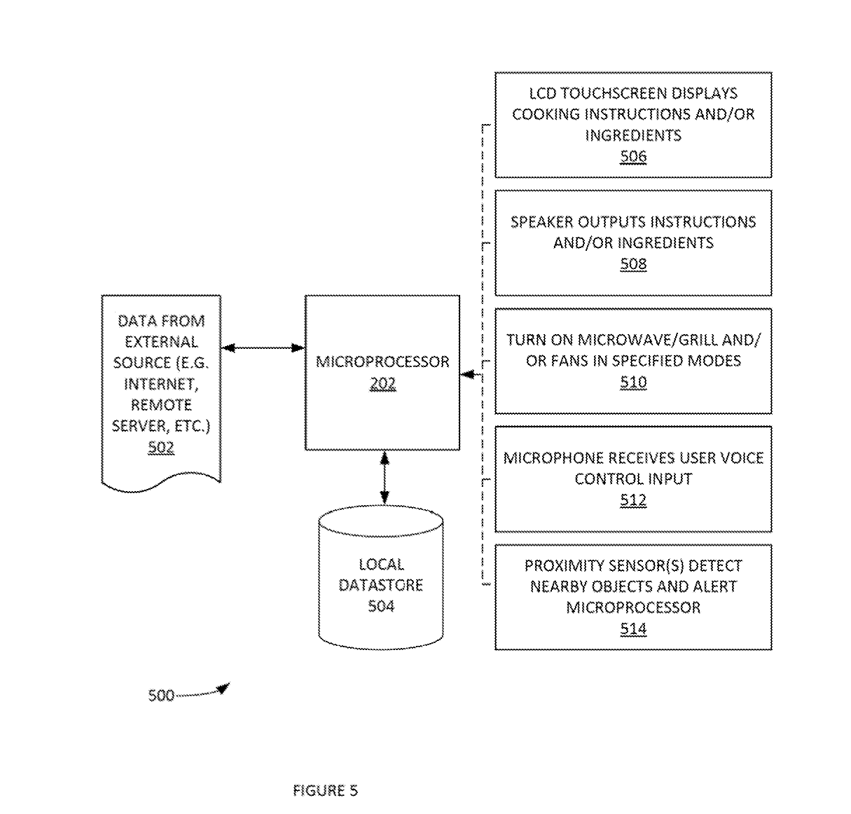

FIG. 5 illustrates an example set of processes 500 performed by microprocessor of a smart-microwave oven, according to some embodiments. Microprocessor can be microprocessor 202 of FIG. 2 supra. More specifically, FIG. 5 illustrates example processes how microprocessor 202 enables a touch console to process data internally. When internet connection is available, microprocessor 202 can synchronize with a recipe database and updates the local datastore 504 with new recipes via data from an external source 502. Virtually, unlimited number of recipes can be stored in this local storage and hence, it offers unlimited dishes for automatic cooking. In process 506, the LCD touchscreen can display cooking instructions (e.g. recipes that include instructions and/or ingredients for a specified set of dishes) and/or ingredients. In process 508, a speaker in the smart oven can output instructions and/or ingredients. In process 510, the smart-microwave oven triggering signals from microprocessor 202 can turn on microwave/grill and/or fans in specified modes (e.g. temperature control, etc.). In process 512, the user can input smart-microwave oven controls via voice commands received by microphones. In process 514, proximity sensor(s) detect nearby objects and alert microprocessor 202.

In one example of process 500, microprocessor 202 is connected to the LCD touch panel which displays ingredients list and each step of cooking. All the available recipes and their details are listed in this touch panel according to the categories. The touch panel also takes user input and sends it to the microprocessor. The microprocessor fetches the recipe according to the user's choice only. A speaker can reads out the instructions step by step. This voice assisted cooking is easier and more efficient. A microphone can record a user's voice in a computer-readable medium and pass that data to microprocessor 202 for processing. A proximity sensor can detect any objects in near a specified surface of microprocessor 202. Microprocessor 202 can take corresponding actions based on that input. In the event that a step in the recipe is an oven triggering signal (e.g. an instruction to switch on the microwave/grill/fan/convection for a given time period) then microprocessor 202 communicates this instruction to the oven relays to perform a specified action.

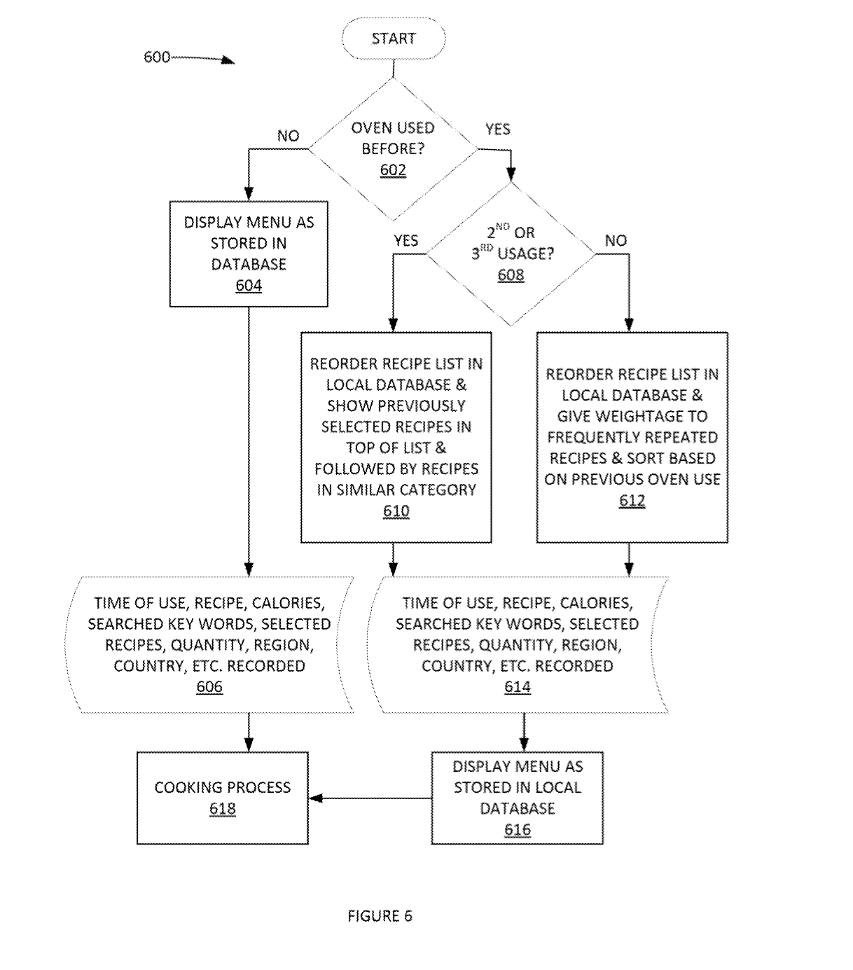

FIG. 6 illustrates a process flow 600 of control of personalization of a smart-microwave oven based on user preferences (e.g. recipes, region and/or country), according to some embodiments. In step 602 of process 600, it can be determined if the smart-microwave oven has been used at least once. If yes, then process 600 proceeds to step 604. In step 604, a display of the smart-microwave oven can display a menu as stored in a specified database. In step 606, various current information (such as, inter alia, time of use, recipe, calories, searched key words, selected recipes, quantity, region, country, etc.) can be recorded. If no, then process 600 proceeds to step 608. In step 608, it can be determined the smart-microwave oven has been used two or three times. If yes, process 600 proceeds to step 610. In step 610, the recipe list is reordered in a local database and previously selected recipes in top of list are displayed followed by recipes in similar category. In no, process 600 proceeds to step 612. In step 612, the recipe list in local database is reordered. Weightage to frequently repeated recipes can be provided and sorted based on previous smart-microwave oven use. Process 600 then proceeds to 614. In step 614, various current information (such as, inter alia, time of use, recipe, calories, searched key words, selected recipes, quantity, region, country, etc.) can be recorded. In step 616, the menu as stored in the local database is displayed. In step 618, a specified cooking process is implemented.

In one example of process flow 600, a smart-microwave oven can start for the first time. Smart-microwave oven can display recipes based on categories which is stored in local database. The user can then select the recipe of the user's preference from list. During this process the smart-microwave oven can record time of use, type of recipe, search query, if any, selected recipes, calories of the recipe selected, quantity, region and/or country. During the next oven use, the recipes can be reordered and displayed in such a way that the previously selected recipes and the ones that are similar to it will be shown on top of list. From the third time usage of smart-microwave oven intelligently displays recipes by reordering the recipes based on comparing and giving weightage to pre-recorded data and sorting the list based on those preferences and its weightage. Each time the smart-microwave oven learns user preferences by recording time of use, type of recipe, selected recipes, calories of the recipe selected, quantity, region and country and continues to learn the user's dietary habits and shows recipes, health tips and cooking tips based on this.

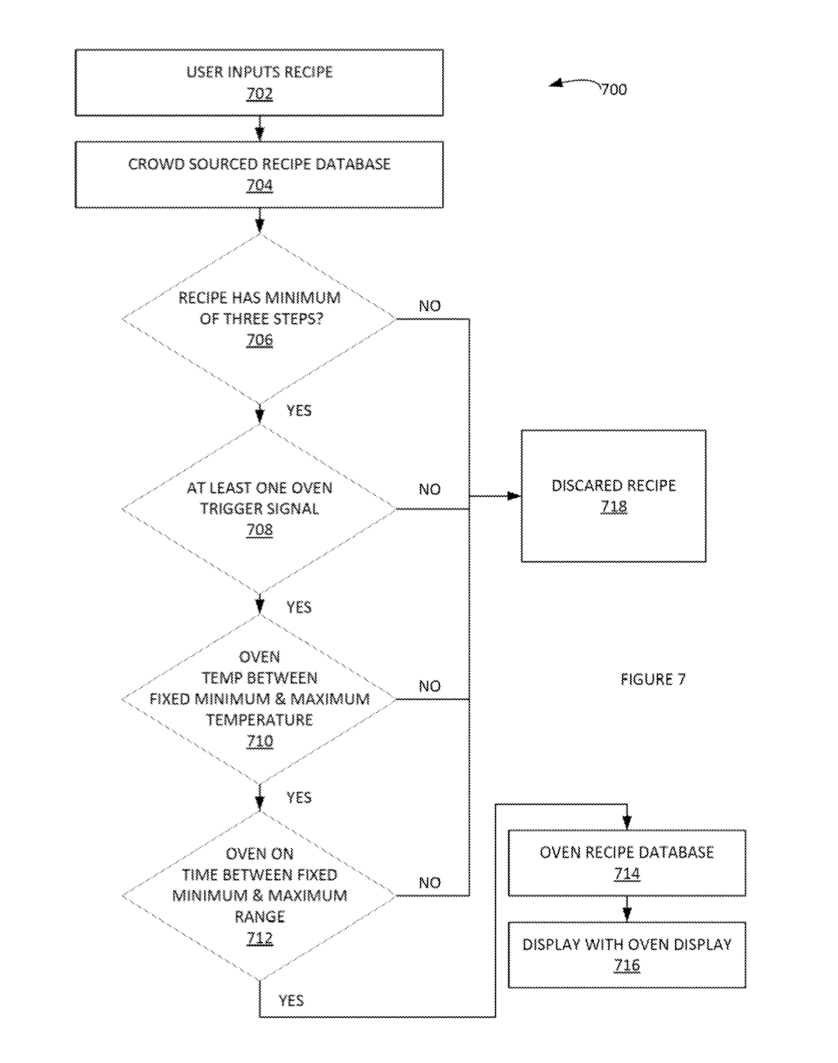

FIG. 7 illustrates a process flow 700 of crowd-sourcing recipes, according to some embodiments. Process flow 700 can include automatically verifications of recipes and/or their inclusion into a smart-microwave oven recipe database. Each crowd-sourced recipe will be checked if it has got at least one oven triggering signal. The recipe can have a minimum of three instructions including a smart-microwave oven trigger signal. The recipe can be checked if the oven temperature and cooking times are within a minimum and maximum range. Smart oven system can have access to these crowd sourced recipes. A smart-microwave oven users can rate each recipe after cooking and the rating will be synchronized to a central-recipe database server. Based on these ratings the recipes can be sorted (e.g. highest-rated recipes higher on the recipe list). The smart-microwave oven user can also include an option to edit the recipes and/or locally store recipes in the smart-microwave oven based on the user's preference and taste.

In step 702, the user input a recipe. In step 704, the recipe is included in a crowd-sourced recipe database (e.g. in a remote server and/or in a cloud-computing platform). In step 706, it can be determined if the recipe has a minimum of three steps. If yes, process 700 proceeds to step 708. In step 708, it can be determined if at least one smart-microwave oven trigger is included in the recipe. If yes, process 700 proceeds to step 710. In step 710, it can be determined if the smart-microwave oven temperature for the recipe is fixed between a minimum and maximum temperature. If yes, process 700 proceeds to step 712. In step 712, it can be determined if the smart-microwave oven cooking time for the recipe is fixed between a minimum and maximum time range. If yes, process 700 proceeds to step 714. In step 714, the recipe can be included in a recipe database. In step 716, the recipe can be accessed by the smart-microwave oven and displayed on the smart-microwave oven's display (and/or other user interface such as provided via a speaker phone, etc.).

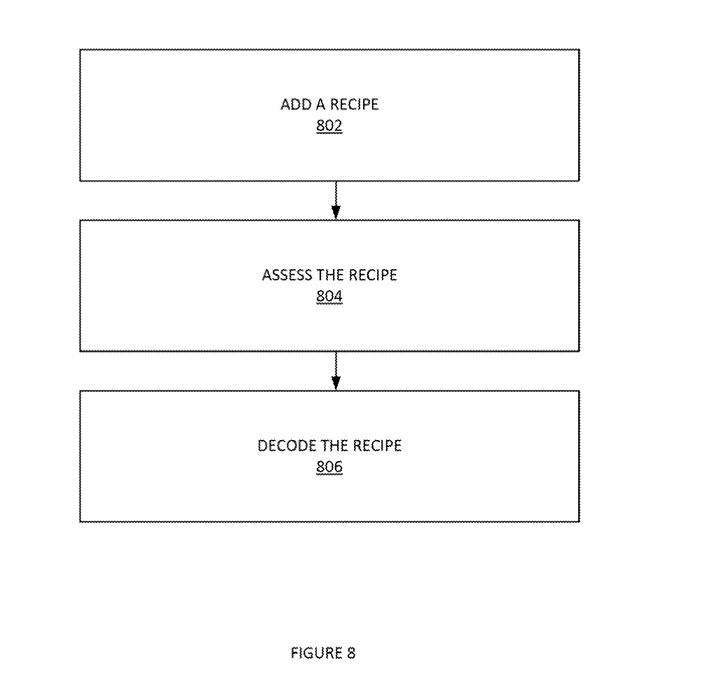

FIG. 8 illustrates an example process 800 for decoding a recipe for a smart-microwave oven, according to some embodiments. In step 802, a recipe can be added to a recipe database (e.g. the recipe databases provided herein). For example, a text-entry field can be used by the user to enter recipe into the database. Each recipe step can be entered into a separate field. Each recipe step and/or ingredient can have a separate entry field. These recipe steps ca be stored in a file in Unicode format and/or the file name is associated to the recipe name and attributes in a database table. Each recipe can have attributes such as, inter alia: time, main ingredient, time of the day (e.g. breakfast, lunch, dinner). In step 804, a recipe can be accessed. For example, when a recipe is requested by name or attributes, it can be searched for and the corresponding file is send to the smart-microwave oven. In step 806, a recipe can be decoded. For example, the file is send to the smart-microwave oven when requested. Each recipe step can be obtained individually and analyzed by decoder algorithm. If a smart-microwave oven trigger action is detected, then the step can be converted into a command for the oven (e.g. heat in microwave for 20 minutes). This can be an action the smart-microwave oven uses natural language processing (NLP). This time can be for cooking one portion of the food in standard conditions. In some examples, smart-microwave oven use this time to calculate the cooking time right when it is being done. It calculates by considering the following factors, such as, inter alia: the time for cooking/heating is decided on the quantity of food in the microwave oven; the present temperature of the food is noted and the cooking/heating time is calculated according to that; the piece size is noted and cooking/heating time is calculated on it. Smart-microwave oven can include various sensors in place for calculating all these factors.

Example Use Cases

The smart-microwave oven can be a microwave oven that has smartness integrated to it. The smart-microwave oven can utilize an Android® or Linux® powered panel compared to ordinary user consoles. The smart-microwave oven can synchronize recipes from the Internet (and/or other remote database) and cook dishes automatically once the ingredients required are provided. Dishes can be cooked automatically. The user need not know any recipes or how to operate an oven. The smart-microwave oven can stream cookery videos from the Internet (and/or other remote database) so that the user can cook a dish while watching the video. The smart-microwave oven can include an ingredients search functionality. The ingredients search functionality can enable the user clicks on the name of an ingredient and the user is shown an image of the same. This can assist in identifying ingredients. The user also has the provision for entering his/her own recipes which will be stored in the smart-microwave oven and can be used for cooking later. The user can also share recipes through online social media websites. The smart-microwave oven can be controlled by user's voice using voice recognition technology. Also user can give instructions to the smart-microwave oven using proximity sensor. The smart-microwave oven can connect to the Internet and updates its recipe database with the new recipes in a remote database. The smart-microwave oven can also retrieve relevant video files and stored in its database. Required videos can be downloaded from the Internet and played with a video player in the smart-microwave oven.

The Android® and/or Linux® operating systems can provide a GUI for the smart-microwave oven (and/or other type of smart oven). The operating system can receives the input from the user and processes it and passes the corresponding actions to a microcontroller. The operating system can work as the embedded operating system for the smart-microwave oven. The operating system can process voice of the user (e.g. with voice recognition algorithms) and/or user's input on a proximity sensor (and/or other type of user gesture input system) and perform corresponding instructions. Instructions can also be received from a touch screen system. For example, a user selects a corresponding food-item dish from a main menu in touch screen LCD display and device checks whether dish is available or not in the local storage. In case dish is not available in data of device, the device downloads the recipe list as well as cooking methods from the internet from a common recipe portal website and shows the user how to cook along with voice assist. The user performs the corresponding actions prescribed by the smart-oven system and closes the door then the oven self-adjust the temperature and time for cooking that dish. The Android® or Linux® operating systems can manage a GUI for the smart-oven system. It receives the input from the user and processes it and passes the corresponding actions to a microcontroller. The microprocessor also obtain input from a microphone. The microcontroller can turns on/off the grill, microwave, convection, fan, motor relays, etc. The smart-microwave oven can be controlled over a phone via Bluetooth®.

An example of recipe personalization is now provided. The list of recipes can be personalized based on the such factors as, inter alia: last cooked dish; recently cooked dishes; main ingredients often cooked; body-mass-ratio (BMR) of the user; time of the day (e.g. breakfast, lunch or dinner); user feedback (e.g. up-votes & down-votes, etc.). A recipes table can shows the list of recipes with associated weights. These weights can used to calculate the priority of the dish in the list. In one example, each recipe can have a base weight of one-hundred (100). The last-cooked date can be provided. By default, the last-cooked date can be the 25th June 2012. The number of up-votes and down-votes received for every recipe can be provided. A caloric value of one serving (e.g. in kCal) can be provided. An ingredients table can show a list of ingredients with associated weights. These weights can be used to order recipes containing those ingredients in the recipe list. Every ingredient can have an initial base weight of one-hundred (100). Every recipe can be mapped to one main ingredient. One method of calculating a BMR of a user (e.g. according to the Harris-Benedict equation) can be: Man=88.362+(13.397*weight in kg)+(4.799*height in cm)−(5.677*age in years); Woman=447.593+(9.247*weight in kg)+(3.098*height in cm)−(4.330*age in years) with kCal needed per day=BMR*1.55 (for an average person). If details are not provided, then kCal needed=2000 kilocalories (kCals). Recipes, while uploading, can be tagged with options like breakfast, lunch, dinner, etc. This would be matched with the time of cooking and considered for priority ordering. Recipes can be up-voted and down-voted. This affects the recipe listing globally and is given less priority. When cooking, the total number of recipes be some a first variable and total number of ingredients be a second variable. Once an ingredient is searched, then a score (e.g. of 100/(the second variable)) and can be added to the ingredient's score. When a recipe is selected for cooking, then a score of (e.g. 100/(the first variable)) can be added to the recipe's score. The last cooked time can be updated. The main ingredient of the recipe selected for cooking gets a score of (100/(the second variable) can be added to the score. A recipe can be up-voted or down-voted after and only after cooking it. Average kCal consumed per day per person can be updated. While listing recipes, the time of the day can be checked (e.g. breakfast, dinner and/or lunch). The last cooked dish for that time of day can be automatically brought to the top of the recipe list. The score of every other recipe can be calculated. For example, an ingredient score can equal the score of the main ingredient of the recipe. The recipe temperature can equal the recipe score divided by the time since last cooked. The time since last cooked can be set to the current UNIX timestamp minus the last cooked timestamp. A vote ratio can be calculated based on the following equation: vote ratio=(1+up-votes)/(1+down-votes). A net recipe score can be calculated based on the following equation: net recipe score+recipe score+recipe temperature+ingredient score+vote ratio. The required kCal for the day can be calculated from the already obtained value. In one example, for breakfast, half of the value may be used. For lunch and/or dinner, a quarter of the value is taken. This can be set as the kCal value. A kCal score of a recipe can be calculated based on the following equation: kCal score of a recipe=(required kCal value−kCal value of the recipe)/1000 and multiply with −1 if negative value. A final recipe score of a recipe can be calculated based on the following equation: final recipe score=net recipe score−kCal score of a recipe. Accordingly, recipes with closer value to average kCal requirements stay on top. A descending order list is made based on the final recipe score of every recipe. This list of (x−1) items is divided into (x−1)/10 equal arrays. Every array is then sorted according to the current time of the day−breakfast->lunch->dinner->breakfast . . . . This ensures that most probable item to be cooked stays on top of the list. All the ((the first variable)−1)/10 arrays can be appended back together to form the final list of recipes.

At least some values based on the results of the above-described processes can be saved for subsequent use. Additionally, a computer-readable medium can be used to store (e.g., tangibly embody) one or more computer programs for performing any one of the above-described processes by means of a computer. The computer program may be written, for example, in a general-purpose programming language (e.g., Pascal, C. C++, Java, Python) and/or some specialized application-specific language (PHP, Java Script, XML).

### B. CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it will be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

What is claimed as new and desired to be protected by Letters Patent of the United States is:

1. A smart-oven system comprising:
a recipe module accessing a remote recipe database that comprises one or more recipe instructions, and downloading a downloaded recipe instruction to a local memory of the smart oven;
a user-input module receiving a user-specified cooking instruction;
a cooking module managing one or more oven heating mechanisms in the smart oven according to the downloaded recipe instruction and the user-specified cooking instruction;
a personalization module obtaining a personalized recipe from a user of the smart oven and uploading the personalized recipe to a remote recipe database; and
a crowd sourcing module recording a user-entered recipe instruction and automatically calculating a cooking time for the user-entered recipe instruction.

2. The smart-oven system of claim 1, wherein the user-specified cooking instructions comprise a modification of the downloaded recipe.

3. The smart-oven system of claim 2, wherein the modification of the downloaded recipe is uploaded by the personalization module to the remote recipe database.

4. The smart-oven system of claim 3, wherein the modification of the downloaded recipe is stored in the remote recipe database if the modification of the downloaded recipe comprises a minimum of three steps, at least one oven trigger signal, a fixed temperature range, and a fixed cooking time range.

5. The smart-oven system of claim 4, wherein the downloaded recipe instruction comprises a computer-readable instruction that triggers one or more smart-oven cooking mechanisms.

6. The smart-oven system of claim 5, wherein the smart oven comprises a smart-microwave oven.

7. The smart-oven system of claim 5 further comprising:
a gesture-recognition input system obtaining user gesture input to provide cooking instructions to the smart-oven system.

8. The smart-oven system of claim 5 further comprising:
a voice-recognition input system obtaining user voice input to provide cooking instructions to the smart-oven system.

9. The smart-oven system of claim 8, wherein an operating system of the smart-oven system comprises an Android® operating system or a Linux® operating system.

10. The smart-oven system of claim 9, where the operating system comprises a text-to-speech module for converting a recipe-instruction text to a computer-voice output.

11. The smart-oven system of claim 10, wherein the crowd-sourcing module learns a recipe update used by the user and saves the recipe update to the remote recipe database or the local memory of the smart oven.

12. The smart-oven system of claim 1, wherein the user-entered recipe instruction comprises a complete recipe to be uploaded in an online recipe store.

13. A computerized system of a smart-microwave oven comprising:
a processor configured to execute instructions;
a memory containing instructions when executed on the processor, causes the processor to perform operations that:
accessing a remote recipe database that comprises one or more recipe instructions, and downloading a downloaded recipe instruction to a local memory of the smart oven;
receiving a user-specified cooking instruction;
managing one or more oven heating managers and timing managers in the smart oven according to the downloaded recipe instruction and the user-specified cooking instruction; and
obtaining a personalized recipe from a user of the smart oven and uploading the personalized recipe to a remote recipe database.

14. The computerized system of the smart-microwave oven of claim 13, wherein the memory containing instructions when executed on the processor, further causes the processor to perform operations that:
record a user-entered recipe instruction; and
automatically calculate a cooking time for the user-entered recipe instruction.

15. The computerized system of the smart-microwave oven of claim 13, wherein the user-specified cooking instructions comprise a modification of the downloaded recipe.

16. The computerized system of a smart-microwave oven of claim 15, wherein the modification of the downloaded recipe is uploaded by the personalization module to the remote recipe database.

17. The computerized system of the smart-microwave oven of claim 16, wherein the modification of the downloaded recipe is stored in the remote recipe database if the modification of the downloaded recipe comprises a minimum of three steps, at least one oven trigger signal, a fixed temperature range, and a fixed cooking time range.

18. The computerized system of the smart-microwave oven of claim 17, wherein the downloaded recipe instruction comprises a computer-readable instruction that triggers one or more smart-oven cooking mechanisms.
